(19) United States
(12) Patent Application Publication
(10) Pub. No.: US 2017/0367097 A1
(43) Pub. Date: Dec. 21, 2017

(54) METHOD AND APPARATUS FOR HANDLING RADIO LINK FAILURE IN MOBILE COMMUNICATION SYSTEM

(71) Applicant: ELECTRONICS AND TELECOMMUNICATIONS RESEARCH INSTITUTE, Daejeon (KR)

(72) Inventors: Kyung Yeol SOHN, Daejeon (KR); Jisoo PARK, Daejeon (KR); Hoon LEE, Daejeon (KR)

(21) Appl. No.: 15/625,071

(22) Filed: Jun. 16, 2017

(30) Foreign Application Priority Data
Jun. 17, 2016 (KR) 10-2016-0076043
Jul. 19, 2016 (KR) 10-2016-0091645

(51) Int. Cl. H04W 72/04; H04W 76/02; H04W 56/00; H04W 72/08; H04W 74/00; H04W 74/08; H04W 88/10

(52) U.S. Cl. CPC H04W 72/0466; H04W 74/006; H04W 76/027; H04W 74/0833; H04W 56/001; H04W 72/085; H04W 72/042; H04W 88/10

(57) ABSTRACT

A base station (BS) of a mobile communication system receives a candidate list including a candidate remote radio head (RRH) adjacent to the UE, excluding at least one serving RRH connected to the UE, among a plurality of RRHs, from the UE, allocates a random access code index to at least one candidate RRH included in the candidate list, and subsequently transmits the random access code index allocated to the at least one candidate RRH to the UE.

### CROSS-REFERENCE TO RELATED APPLICATION(S)

This application claims priority to and the benefit of Korean Patent Application Nos. 10-2016-0076043 and 10-2016-0091645, filed in the Korean Intellectual Property Office on Jun. 17, 2016 and Jul. 19, 2016, respectively, the entire contents of which are incorporated herein by reference.

### BACKGROUND OF THE INVENTION

### 1. Field of the Invention

The present invention relates to a method and apparatus for handling a radio link failure in a mobile communication system and, more particularly, to a method and apparatus for handling a radio link failure that frequently occurs due to movement of a terminal in a mobile communication system of a cloud radio access network (C-RAN) to which a millimeter wave-based remote radio head (RRH) is applied.

### 2. Description of Related Art

Research into the use of a millimeter wave (mmWave) band to secure an effective bandwidth of 1 GHz or greater, rather than an existing cellular band, has been actively conducted to enhance spatial reuse of a frequency and a data rate in a mobile communication system.

In addition, in order to enhance quality of a mobile communication service, as well as satisfying recently increased wireless data traffic demand, a size of cells is decreased, the number of cells is increased, and wireless access technologies tend to be more elaborate and complicated to increase spatial reuse efficiency of a frequency. The increase in cells and progress in network incur high cost for cell installation and operation, laying a considerable burden on communication providers. As a solution, C-RAN technologies using an RRH, one of methods of providing a high speed wireless data service, while minimizing cost for advanced communication network, has been developed. A method for configuring a user-centric virtual cell, capable of simplifying an unnecessary handover procedure, while maintaining a user experienced data to rate in consideration of enhancement of performance in a cell boundary regarding a user which is located in the cell boundary or has high mobility, a problem which remains unsolved in an existing cellular system, has also be studied.

However, in the case of the C-RAN structure using millimeter wave-based RRH, an area in charge of each RRH is limited due to constraints of pathloss due to the use of a high frequency, poor penetration, and in particular, guaranteeing a line of sight (LOS), unlike transmission using an existing cellular band. In addition, since LOS is not secured due to movement of a user equipment (UE), a radio link established between the UE and a base station (BS) is frequently cut off.

Therefore, a method for rapidly handling a failure of a radio link which frequently occurs due to movement of a UE which is located in a cell boundary or which has high mobility in a millimeter wave-based mobile communication system of a C-RAN environment to which an RRH reducing installation cost of a BS and facilitating management, compared with the related art BS system, is required.

### SUMMARY OF THE INVENTION

The present invention has been made in an effort to provide a method and apparatus for handling a failure of a radio link in a mobile communication system having advantages of rapidly handling a failure of a radio link established between a base station (BS) and a user equipment (UE) due to a movement of the UE in the mobile communication system of a millimeter based-based RRH-applied C-RAN environment.

An exemplary embodiment of the present invention provides a method for handling a radio link failure in a base station (BS) of a mobile communication system. The method for handling a radio link failure may include: receiving, from a user equipment (UE), a candidate list including a candidate remote radio head (RRH) adjacent to the UE, excluding at least one serving RRH connected to the UE, among a plurality of RRHs; allocating a random access code index to at least one candidate RRH included in the candidate list; and transmitting, to the UE, the random access code index allocated to the at least one candidate RRH.

The method for handling a radio link failure may further include: when a failure in a radio link established between the at least one serving RRH and the UE is detected, processing a random access between a target candidate RRH with strongest signal strength received from the UE on the candidate list and the UE; and establishing a radio link between the target candidate RRH and the UE.

The processing of random access may include: receiving a random access preamble transmitted from the UE using the random access code index allocated to the target candidate RRH; and transmitting a random response message regarding the random access preamble.

The process of random access may further include: transmitting the random access code index allocated to the target candidate RRH to the target candidate RRH.

The method for handling a radio link failure may further include: transmitting a synchronization signal including a physical layer cell ID and a to reference signal including a unique identifier of a corresponding RRH through a plurality of RRHs, before the candidate list is received from the UE, wherein the candidate list includes a unique identifier of the candidate RRH.

The candidate list may further include a relative reference time difference of a signal received from the candidate RRH with respect to a reference signal of a signal received from the serving RRH, and the relative reference time difference is used as an uplink timing adjustment value for random accessing the candidate RRH.

When signal strength of a synchronization signal received by the UE continuously exceeds a preset first threshold by a predetermined first number of times and a unique identifier obtained through a reference signal is the same for the first number of times, an RRH which has transmitted the corresponding synchronization signal and the reference signal may be added as the candidate RRH to the candidate list, and when signal strength of a synchronization signal received by the UE does not continuously exceed a preset second threshold by a predetermined second number of times, a candidate RRH which has transmitted the corresponding synchronization signal and the reference signal may be deleted from the candidate list.

The allocating may include: allocating a random access code index to the candidate RRH when the candidate RRH is first reported through the candidate list; and maintaining the random access code index allocated to the candidate RRH until the candidate RRH is deleted from the candidate list.

Another exemplary embodiment of the present invention provides a method for handling a radio link failure in a user equipment (UE) of a mobile to communication system. The method for handling a radio link failure may include: configuring a candidate list including at least one candidate remote radio head (RRH) adjacent to the UE, excluding at least one serving RRH to which the UE is connected, among a plurality of RRHs; receiving a random access code index of the at least one candidate RRH allocated by a base station (BS), through the serving RRH; and adding the random access code index of the at least one candidate RRH to the candidate list.

The method for handling a radio link failure may further include: when a failure that occurs in a radio link established between the at least one serving RRH and the UE is detected, performing random access with a target candidate RRH using a random access code index of the target candidate RRH with strongest signal strength received from the UE on the candidate list; and establishing a radio link with the target candidate RRH.

The configuring may include: receiving synchronization signals including a physical layer cell ID and reference signals including a unique identifier of a corresponding RRH from the plurality of RRHs; selecting the serving RRH and the candidate RRH from among the plurality of RRHs using the synchronizations and the reference signals; and generating a candidate list including the candidate RRH and transmitting the generated candidate list to the BS through the serving RRH.

The selecting may include: selecting an RRH which has transmitted a synchronization signal with strongest signal strength among signal strengths of synchronization signals received from the plurality of RRHs, as the serving RRH; and when signal strength of a synchronization signal among to synchronization signals and reference signals received from the plurality of RRHs continuously exceeds a preset first threshold by a predetermined number of times and a unique identifier transmitted through a received reference signal is the same for the first number of times, selecting an RRH which has transmitted the corresponding synchronization signal and the reference signal as the candidate RRH.

The selecting may further include: when signal strength of a synchronization signal of the candidate RRH does not continuously exceed a preset second threshold by a predetermined second number of times, deleting the corresponding candidate RRH from the candidate list.

The transmitting may include: calculating a relative reference time difference of a synchronization signal received from the candidate RRH with respect to a reference time of a synchronization signal received from the at least one serving RRH; and generating a candidate list including a unique identifier of the candidate RRH obtained through the reference signal received from the candidate RRH and the relative reference time difference of the candidate RRH.

The performing of random access may include: adjusting an uplink timing based on a RRH with the fastest transmission time using relative reference time differences calculated with respect to the serving RRH and the target candidate RRH.

Yet another exemplary embodiment of the present invention provides an apparatus for handling a radio link failure in a user equipment (UE) of a mobile communication system. The apparatus for handling a radio link failure may to include: a candidate list configuring unit, a random access processing unit, and a radio link connection unit. The candidate list configuring unit may select a candidate remote radio head (RRH) adjacent to the UE, excluding a serving RRH to which the UE is connected, among a plurality of RRHs connected to a single baseband unit (BBU) pool, configure a candidate list including the candidate RRH, add a random access code index allocated to the candidate RRH to the candidate list, and manage the candidate list. The random access processing unit may perform random access with a target adjacent RRH using a random access code index allocated to the target adjacent RRH with strongest signal strength received from the UE, on the candidate list, when a failure occurs in a radio link established between the serving RRH and the UE. The radio link connection unit may connect the target candidate RRH and a radio link, when the random access is completed.

The apparatus for handling a radio link failure may further include: a transceiver unit receiving synchronization signals each including a physical layer cell ID and reference signals including a unique identifier of a corresponding RRH from the plurality of RRHs, wherein the candidate list configuring unit may select an RRH which has transmitted a synchronization signal with strongest signal strength among signal strengths of synchronization signals received from the plurality of RRHs, as the serving RRH, and when a signal strength of a received synchronization signal continuously exceeds a preset first threshold by a predetermined first number of times and a unique identifier transmitted through the received reference signal is the same for the first number of times, the candidate list configuring unit may select an RRH to which has transmitted the corresponding synchronization signal and the reference signal, as the candidate RRH.

The radio link connection unit may perform a radio resource control (RRC) connection re-establishment procedure to connect the target candidate RRH and a radio link.

The candidate list configuring unit may calculate a relative reference time difference of a synchronization signal received from the candidate RRH with respect to a reference signal of a synchronization signal received from the serving RRH, and the candidate list may include a unique identifier of the candidate RRH obtained through a reference signal received from the candidate RRH and a relative reference time difference of the candidate RRH.

The random access processing unit may adjust an uplink timing based on a RRH with the fastest transmission time using the relative reference time differences calculated with respect to the serving RRH and the target candidate RRH.

### BRIEF DESCRIPTION OF THE DRAWINGS

FIG. 1 is a view illustrating a remote radio head (RRH)-applied millimeter wave-based mobile communication system according to an exemplary embodiment of the present invention.

FIG. 2 is a view illustrating a communication environment between a plurality of RRHs and a UE according to an exemplary embodiment of the present invention.

FIG. 3 is a view illustrating a relative reference time difference included in a candidate list in the communication environment of FIG. 2.

FIG. 4 is a view illustrating a communication environment between a plurality of RRHs and a UE according to another exemplary embodiment of the present invention.

FIG. 5 is a view illustrating a relative reference time difference included in a candidate list in the communication environment of FIG. 4.

FIG. 6 is a flow chart illustrating an operation of a base station (BS) for managing an RRH according to an exemplary embodiment of the present invention.

FIG. 7 is a flow chart illustrating an operation of a user equipment (UE) for managing an RRH according to an exemplary embodiment of the present invention.

FIGS. 8 to 11 are views illustrating a procedure for handling a radio link failure according to an exemplary embodiment of the present invention.

FIG. 12 is a view illustrating an apparatus for handling a radio link failure in a BS according to an exemplary embodiment of the present invention.

FIG. 13 is a view illustrating an apparatus for handling a radio link failure in a UE according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings to and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), or a user equipment (UE), and may include the entirety or a portion of functions of the MT, MS, AMS, HR-MS, SS, PSS, AT, or UE.

Also, a base station (BS) may refer to an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, small base stations (BSs) (e.g., a femto base station (BS), a home node B (HNB), a home eNodeB (HeNB), a pico BS, a metro BS, a micro BS, etc.), and the like, and may include the entirety or a portion of functions of an ABS, a node B, an eNodeB, an AP, an RAS, a BTS, an MMR-BS, an RS, an RN, an ARS, an HR-RS, a small BS, and the like.

Hereinafter, a method and apparatus for managing a remote radio head to (RRH) in a mobile communication system according to an exemplary embodiment of the present invention will be described in detail with reference to the accompanying drawings.

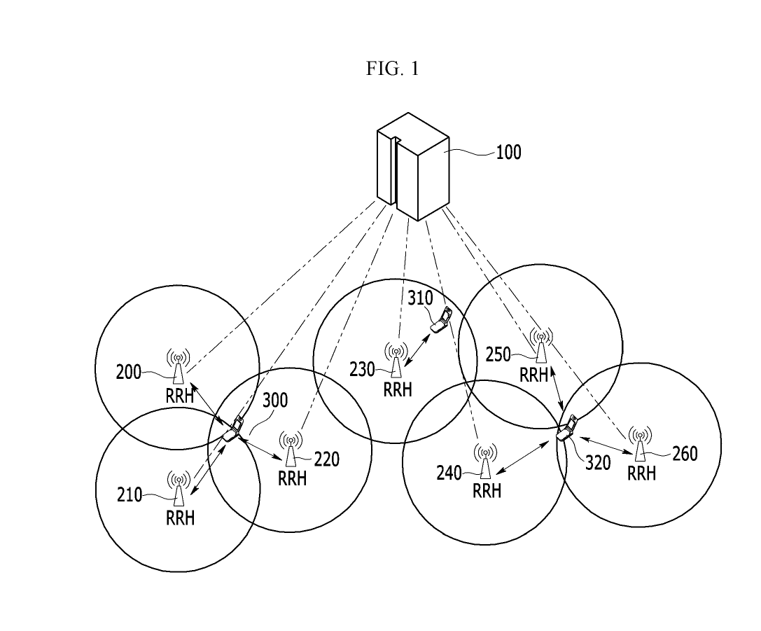

FIG. 1 is a view illustrating a remote radio head (RRH)-applied millimeter wave-based mobile communication system according to an exemplary embodiment of the present invention

Referring to FIG. 1, a base station (BS) of an RRH-applied millimeter wave-based mobile communication system separately operates a plurality of RRHs 200, 210, . . . , 260 amplifying a radio frequency (RF) signal and radiating the amplified RF signal to an antenna within a service area and a baseband unit (BBU) pool 100 responsible for controlling and signal processing.

The plurality of RRHs 200, 210, . . . , 260 are distributed within a cell managed by the BS and connected to the BBU pool 100 through an optical cable, or the like. Each of the plurality of RRHs 200, 210, . . . , 260 may use a millimeter wave frequency band of 10 GHz or higher as a carrier frequency, and use a bandwidth from hundreds of MHz to 1 GHz or higher for data transmission.

The plurality of RRHs 200, 210, . . . , 260 connected to the same BBU pool 100 simultaneously transmit a synchronization signal including the same physical layer cell ID (PCID) to user equipments (UEs) 300, 310, and 320 using the same radio resource. During this process, the plurality of RRHs 200, 210, . . . , 260 interfere with each other because they transmit different data using the same radio resource. Thus, the plurality of RRHs 200, 210, . . . , 260 transmit a unique identifier (ID) identifying each RRH to the UEs 300, 310, and 320 using to a reference signal for alleviating interference of signals transmitted by neighboring RRHs. Here, radio resource refers to a resource element of a time and frequency space defined in 3GPP LTE/LTE-A (Advanced) specification, and it is assumed that radio frames transmitted from the plurality of RRHs 200, 210, . . . , 260, subframes forming the radio frames, and symbols are in synchronization.

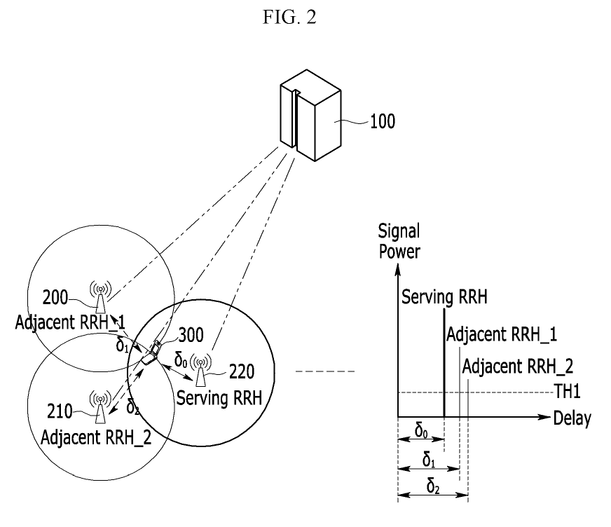

FIG. 2 is a view illustrating a communication environment between a plurality of RRHs and a UE according to an exemplary embodiment of the present invention.

Referring to FIG. 2, the plurality of RRHs 200, 210, and 220 for which the BBU pool 110 is responsible transmit a synchronization signal and a reference signal to the UE 300 at the same time. Here, since relative position of the UE 300 with respect to the RRHs 200, 210, and 220 is different, time delays δ₀, δ₁, and δ₂ occur depending on the relative position of the UE 300.

The UE 300 belonging to an area of the plurality of RRHs 200, 210, and 220 receives the synchronization signals and the reference signals from the plurality of RRHs 200, 210, and 220 after the time delays δ₀, δ₁, and δ₂.

The UE 300 sets a reference time using a synchronization signal of an RRH (e.g., 220) having the largest signal strength among the synchronization signals received from the plurality of RRHs 200, 210, and 220, and determines the RRH 220 as a serving RRH 220 using a unique identifier included in the reference signal of the RRH 220.

When the serving RRH 220 is determined using the synchronization signal and the reference signal, the UE 300 establishes a radio resource control (RRC) connection with the serving RRH 220.

When the UE 300 is switched from an RRC idle (RRC_IDLE) state to an RRC-connected (RRC_CONNECTED) state, the UE 300 continuously searches whether another RRH excluding the serving RRH 220 is present in the vicinity of the UE 300 from synchronization signals received from the plurality of RRHs 200, 210, and 220. The UE 300 starts monitoring to add RRHs 200 and 210, from which synchronization signals received by the UE 300 exceed a preset threshold TH1, to a candidate list. Here, the RRHs 200 and 210 transmitting synchronization signals whose strength exceeds the preset threshold TH1 will be referred to as adjacent RRH_1 200 and an adjacent RRH_2 210. When reception signal strength of the synchronization signals respectively received from the adjacent RRH_1 200 and the adjacent RRH_2 210 after monitoring starts continuously exceeds a preset threshold TH2 a predetermined number of times N1 and unique identifiers transmitted through the reference signals respectively received from the adjacent RRH_1 200 and the adjacent RRH_2 210 are the same the predetermined number of times N1, the UE 300 adds the adjacent RRH_1 200 and the adjacent RRH_2 210, as candidate RRHs, to a candidate list.

When the candidate list is created, the UE 300 transmits the candidate list to the BBU pool 100 through the serving RRH 220 at a predetermined period.

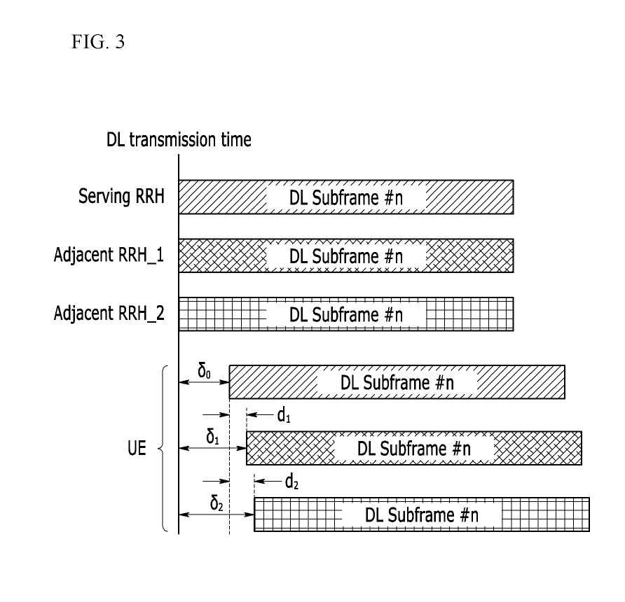

The candidate list transmitted to the BBU pool 100 may include unique identifiers of the adjacent RRH_1 200 and the adjacent RRH_2 210. Also, the candidate list may further include information regarding a relative reference time difference of the synchronization signals received from the candidate RRHs 200 to and 210 with respect to a reference time set on the basis of a synchronization signal from the serving RRH 220. The relative reference time different will be described in detail with reference to FIG. 3.

The BBU pool 100 allocates contention-free-based random access code indices RAₐ and RA_{b} which may be used in a radio link failure or during a handover process with respect to the adjacent RRH_1 200 and the adjacent RRH_2 210 included in the candidate list received from the UE 300 and subsequently transmit the random access code indices RAₐ and RA_{b} to the UE 300 using the serving RRH 220.

The UE 300 adds the random access code indices RAₐ and RA_{b} allocated to the adjacent RRH_1 200 and the adjacent RRH_2 210 to the candidate list. The candidate list may further include the contention-free-based random access code indices RAₐ and RA_{b} regarding the adjacent RRH_1 200 and the adjacent RRH_2 210.

When receive strengths of the synchronization signals from the adjacent RRH_1 200 and the adjacent RRH_2 210 do not continuously exceed a preset threshold TH3 a predetermined number of times N2, the UE 300 may delete the adjacent RRH_1 200 and the adjacent RRH_2 210 included in the candidate list, from the candidate list.

When the candidate list is updated due to deletion of the adjacent RRH_1 200 and the adjacent RRH_2 210 from the candidate list, the UE 300 may transmit the updated candidate list to the BBU pool 100 using the serving RRH 220.

Allocation of the random access code indices RAₐ and RA_{b} may be to performed when the adjacent RRH_1 200 and the adjacent RRH_2 210 in the vicinity of the UE 300 are first reported through the candidate list, and values of the random access code indices RAₐ and RA_{b} may be maintained until the adjacent RRH_1 200 and the adjacent RRH_2 210 are deleted from the candidate list.

FIG. 3 is a view illustrating a relative reference time difference included in a candidate list in the communication environment of FIG. 2.

Referring to FIG. 3, the serving RRH 220 and the candidate RRHs 200 and 210 positioned around the UE 300 are in synchronization, the serving RRH 220 and the candidate RRHs 200 and 210 transmit a synchronization signal and a reference signal through a downlink subframe #n to the UE 300 at the same downlink transmission time T. However, since relative position of the UE 300 with respect to each of the RRHs 200, 210, and 220 is different, time delays δ₀, δ₁, and δ₂ occur.

As described above, the UE 300 sets a reference time of a reception signal using the synchronization signal received from the serving RRH 220.

The UE 300 calculates relative reference time differences (d₁=δ₁−δ₀, d₂=δ₂−δ₀) of the synchronization signals received from the adjacent RRH_1 200 and the adjacent RRH_2 210 with respect to the set reference time. Here, the values of the calculated reference time differences d₁ and d₂ are used as timing adjustment values for random-accessing to a high ranking candidate RRH_1 200 on the candidate list when a radio link between the UE 300 and the serving RRH 220 is cut off.

Table 1 shows an example of a candidate list configured by the UE 300 according to FIGS. 2 and 3.

TABLE 1

| | | Relative reference time difference | | |
|---|---|---|---|---|
| | | Serving | | random |
| List | RRH | RRH [symbol] terminal | | access code |
| number | identifier | (or UE) | — | index |
| 1 | Adjacent | d₁ | — | RAₐ |
| | RRH_1 | | | |
| 2 | Adjacent | d₂ | — | RA_{b} |
| | RRH_2 | | | |

In the case of FIG. 2, since only one serving RRH 220 connected to the UE 300 by a radio link is present, relative reference time differences regarding the candidate RRHs 200 and 210 are respectively present on the candidate list, and in cases where the number of contention-free-based random access code indices which may be allocated by the BBU pool 100 is limited, the BBU pool 100 may allocate the random access code indices only to M number of RRH in a high ranking on the candidate list and transmit the same to the UE 300. Here, order of the candidate RRHs on the candidate list may be determined signal strength of synchronization signals received from the adjacent RRH_1 200 and the adjacent RRH_2 210. For example, the UE 300 may align values obtained by averaging signal strengths of synchronization signals respectively received from the adjacent RRH_1 200 and the adjacent RRH_2 210 the predetermined number of times N1, starting from a largest value, in descending to order.

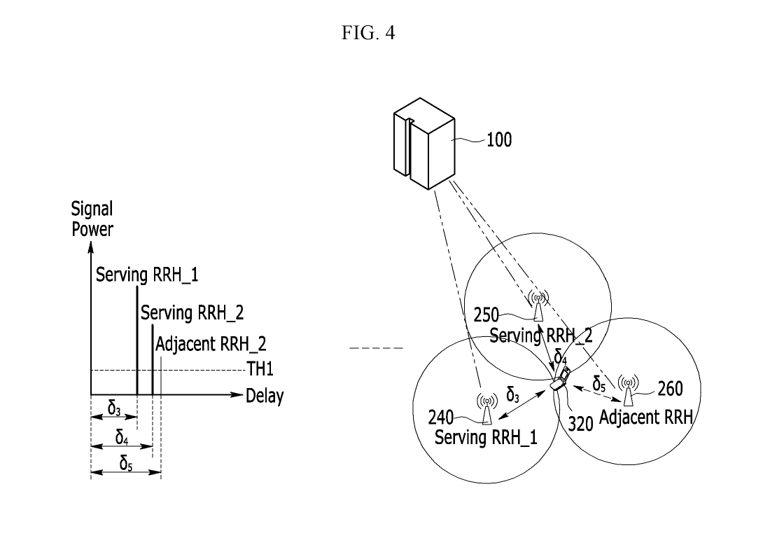

FIG. 4 is a view illustrating a communication environment between a plurality of RRHs and a UE according to another exemplary embodiment of the present invention.

Referring to FIG. 4, a plurality of RRHs 240, 250, and 260 for which the BBU pool 100 is responsible transmit a synchronization signal and a reference signal to a UE 320 at the same time. Here, since a relative position of the UE 320 with respect to the RRHs 240, 250, and 260 is different, time delays δ₃, δ₄, and δ₅ occur depending on a relative position of the UE 320.

The UE 320 included in an area of the plurality of RRHs 240, 250, and 260 receives the synchronization signals and reference signals from the plurality of RRHs 240, 250, and 260 after time delays

Here, the UE 320 included in the area of the plurality of RRHs 240, 250, and 260 may be connected to a plurality of serving RRHs 240 and 250. In a state in which the UE 320 is not connected to an RRH therearound, an RRH (e.g., 240) having strength of a synchronization signal is greatest is determined as the serving RRH 240 and connection is established between the UE 320 and the serving RRH 240. Also, a candidate list is created using the RRH around the UE 320. After this process is completed, when an additional connection is required, an RRH (e.g., 250) whose signal strength is strong on the candidate list may be determined as the serving RRH 250 in a state in which the existing serving RRH 240 is maintained, and connection may be additionally established between the UE 320 and the serving RRH 250.

In an RRC-connected state in which the UE 320 is connected to the to plurality of serving RRHs 240 and 250, the UE 320 continuously searches whether another RRH excluding the serving RRHs 240 and 250 is present around the UE 320 on the basis of synchronization signals received from the plurality of RRHs 240, 250, and 260. Here, for the purposes of description, the two serving RRHs 240 and 250 will be referred to as a serving RRH_1 240 and a serving RRH_2 250, respectively. Among the serving RRH_1 240 and the serving RRH_2 250, it is assumed that the serving RRH_1 240 is a main serving RRH having priority of every connection and the serving RRH_2 250 is an auxiliary serving RRH, and distinguishment of the main serving RRH and the auxiliary serving RRH may be determined according to priority connected to the UE 320.

When signal strength of the synchronization signal received from the adjacent RRH 260, excluding the serving RRH_1 240 and the serving RRH_2 250, exceeds the preset threshold TH1, the UE 320 starts monitoring to add the adjacent RRH 260 to the candidate list.

When signal strength of the synchronization signal received from the adjacent RRH 260 continuously exceeds the preset threshold TH2 the predetermined number of times N1 and a unique identifier transmitted through the reference signal of the adjacent RRH 260 is the same the predetermined number of times N1, the UE 320 adds the adjacent RRH 260 as monitored, as a candidate RRH 260 to the candidate list.

When the candidate list is created, the UE 320 transmits the candidate list to the BBU pool 100 through the serving RRH_1 240 and the serving RRH_2 250 at a predetermined period, but the BBU pool 100 allocates a to contention-free-based random access code index (RA_{c}) which may be used in the occurrence of a radio link failure or during a handover process to the adjacent RRH 260 included in the candidate list received from the UE 320 through the serving RRH_1 240 as a main serving RRH. Also, the BBU pool 100 transmits the contention-free-based random access code index (RA_{c}) allocated to the adjacent RRH 260 to the UE 320 using the serving RRH_1 240 as a main serving RRH.

The candidate list may include information regarding a relative reference time difference of a synchronization signal received from the adjacent RRH 260 to a reference time of synchronization signals respectively received from the serving RRH_1 240 and the serving RRH_2 250 and the contention-free-based random access code index (RA_{c}) allocated to the adjacent RRH 260, as well as the unique identifier of the candidate RRH 260.

When a receive strength of the synchronization signal from the adjacent RRH 260 added to the candidate list does not continuously exceed the preset threshold TH3 the predetermined number of times N2, the UE 320 deletes the candidate RRH 260 from the candidate list.

When the candidate list is updated due to deletion of the adjacent RRH 260 from the candidate list, the UE 320 transmits the updated candidate list to the BBU pool 100 using the serving RRH_1 240.

Allocation of the random access code index (RA_{c}) may be performed when the adjacent RRH 260 near the UE 320 is first reported through the candidate list, and the value of the random access code index (RA_{c}) may be maintained until the adjacent RRH 260 is deleted from the candidate list.

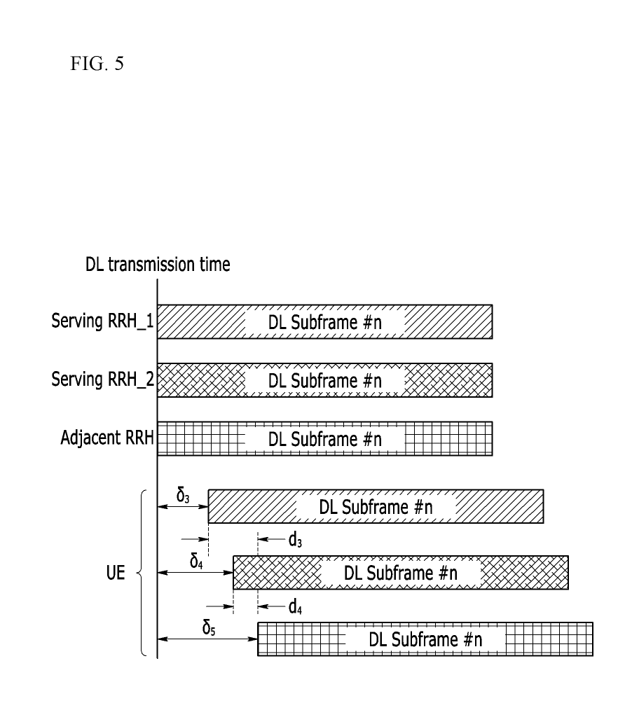

FIG. 5 is a view illustrating a relative reference time difference included in a candidate list in the communication environment of FIG. 4.

Referring to FIG. 5, since signals from the serving RRH_1 240, the serving RRH_2 250, and the candidate RRH 260 positioned around the UE 320 are in synchronization, the serving RRHs 240 and 250 and the candidate RRH 260 transmit a synchronization signal and a reference signal through a downlink subframe #n to the UE 320 at the same downlink transmission time T. However, since relative position of the UE 320 with respect to each of the RRHs 240, 250, and 260 is different, time delays δ₃, δ₄, and δ₅ occur.

As described above, the UE 320 sets a reference time of a reception signal using the synchronization signals respectively received from the serving RRH_1 240 and the serving RRH_2 250.

The UE 320 may calculate relative reference times (d₃=δ₅−δ₃, d₄=δ₅−δ₄) with respect to a reference time of the synchronization signal received from the adjacent RRH 260 from a reference time of the synchronization signals respectively received from the adjacent RRH_1 200 and the adjacent RRH_2 210.

Here, the values of the calculated reference time differences d₃ and d₄ are used as timing adjustment values for random-accessing to a high ranking candidate RRH 260 on the candidate list when a radio link between the UE 320 and the serving RRHs 240 and 250 is cut off.

Table 2 shows an example of a candidate list configured by the UE 320 in accordance with FIGS. 4 and 5.

TABLE 2

| | | Relative reference time difference | | |
|---|---|---|---|---|
| | | Serving | Serving | random |
| List | RRH | RRH_1 [symbol] termi- | RRH_2 [symbol] termi- | access code |
| number | identifier | nal | nal | index |
| 1 | Adjacent | d₃ | d₄ | RA_{c} |
| | RRH | | | |

A relative reference time difference of the candidate RRH 260 on the candidate list to the adjacent RRH_1 200 and the adjacent RRH_2 210 connected to the UE 320 by a radio link is respectively present, and in cases where the number of contention-free-based random access code indices which may be allocated by the BBU pool 100 is limited, the BBU pool 100 may allocate the random access code indices only to M number of RRH in a high ranking on the candidate list and transmit the same to the UE 320. Here, candidate RRHs on the candidate list may be aligned in descending order, starting from a largest one of values obtained by averaging signal strengths of synchronization signals from the candidate RRH 260 received by the UE 320 the predetermined number of times N1.

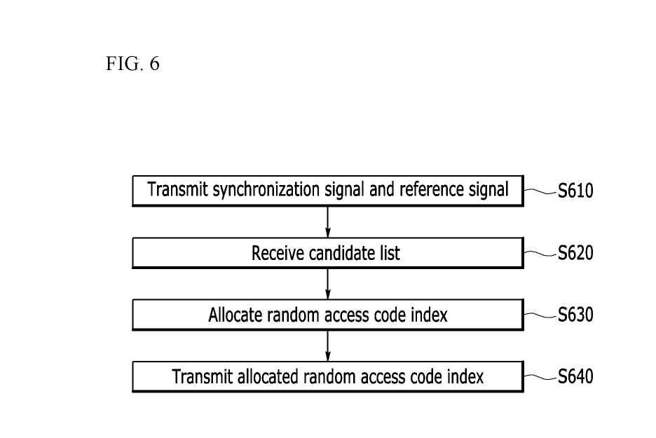

FIG. 6 is a flow chart illustrating an operation of a base station (BS) for managing an RRH according to an exemplary embodiment of the present invention.

Referring to FIG. 6, the BBU pool 100 transmits a synchronization signal and a reference signal to a UE through a plurality of RRHs (S610).

The BBU pool 100 receives a candidate list regarding neighbor RRHs to from the UE (S620).

The BBU pool 100 allocates a random access code index to each of the RRHs included in the received candidate list (S630) and subsequently transmits the allocated random access code index to the UE (S640). The BBU pool 100 may allocate the random access code index when a candidate RRH is first reported through the candidate list transmitted from the UE. Also, the allocated random access code index may be maintained until the corresponding candidate RRH is deleted from the candidate list. When the number of contention-free-based random access code indices which may be allocated is limited, the BBU pool 100 may allocate the random access code indices only to M number of RRH in a high ranking on the candidate list.

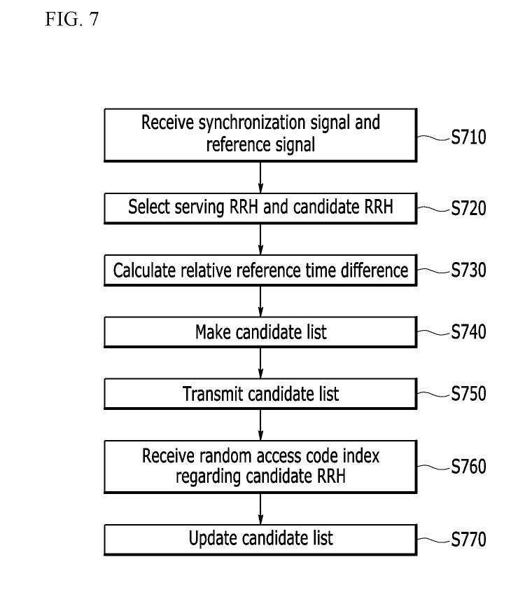

FIG. 7 is a flow chart illustrating an operation of a user equipment (UE) for managing an RRH according to an exemplary embodiment of the present invention. In FIG. 7, for the purposes of description, the UE 300 will be described for reference, but the other UEs 310 and 320 may also operate in the same or similar manner.

Referring to FIG. 7, the UE 300 receives synchronization signals and reference signals transmitted from a plurality of RRHs (S710).

The UE 300 selects a serving RRH using the received synchronization signals and reference signals, and when the UE 300 is connected to the serving

RRH in an RRC-connected state, the UE 300 performs a process of searching for and selecting a candidate RRH (S720).

When a candidate RRH is selected, the UE 300 calculates a relative reference time difference of a synchronization signal received from the to candidate RRH to a reference time of a synchronization signal received from the serving RRH (S730).

The UE 300 configures a candidate list using a unique identifier of the candidate RHH and the calculated reference time difference (S740).

The UE 300 transmits the configured candidate list to the plurality of RRHs (S750).

Thereafter, when a random access code index regarding the candidate RRH included in the candidate list from the serving RRH is received (S760), the UE 300 updates the candidate list including the received random access code index (S770).

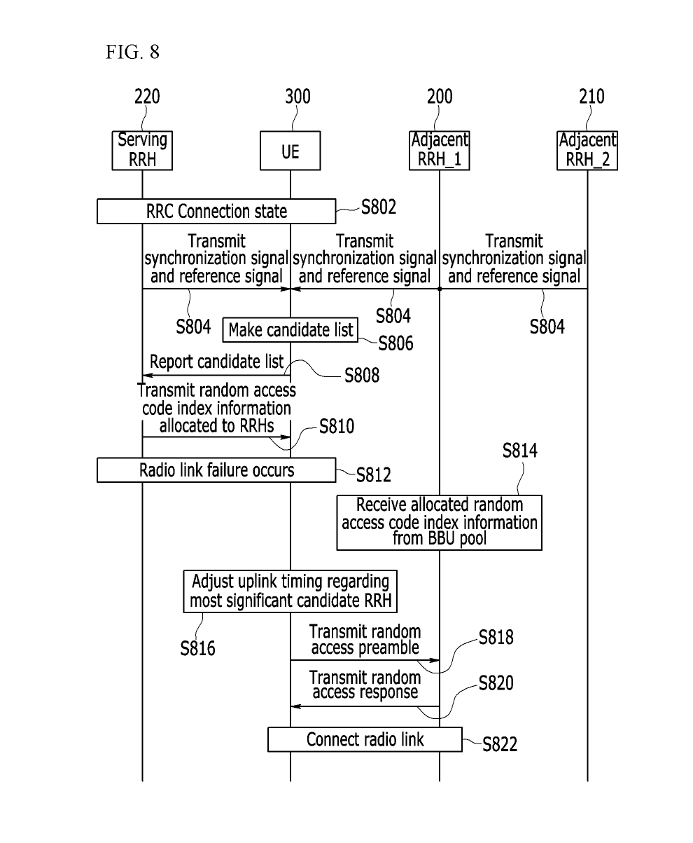

FIG. 8 is a view illustrating a procedure for handling a radio link failure according to an exemplary embodiment of the present invention. A procedure for processing a radio link failure on the basis of a communication environment illustrated in FIG. 2 will be described with reference to FIG. 8.

Referring to FIG. 8, when the serving RRH 200 and the UE 300 are set in an RRC-connected state (S802), the UE 300 receives synchronization signals and reference signals transmitted from the plurality of RRHs 200, 210, and 220 (S804).

The UE 300 performs a process of searching for and selecting a candidate RRH using the received synchronization signals and reference signals. The process (step S806 to S810) of searching for and selecting the candidate RRH and configuring and managing the candidate list are the same as the contents described above with reference to FIGS. 2 and 7. That is, when receive strengths of synchronization signals from the adjacent RRH_1 to 200 and the adjacent RRH_2 210, excluding the serving RRH 220, continuously exceed the preset threshold TH2 the predetermined number of times N 1 and unique identifiers obtained through the reference signals respectively received from the adjacent RRH_1 200 and the adjacent RRH_2 210 are the same the predetermined number of times N 1, the UE 300 registers the adjacent RRH_1 200 and the adjacent RRH_2 210 as candidate RRHs and configures a candidate list including the candidate RRHs (S806). The UE 300 periodically reports the candidate list to the BBU pool 100 through the serving RRH 220 (S808). The BBU pool 100, which has received the candidate list from the UE 300, allocates random access code indices for contention-free-based random access which may be used by M number of candidate RRHs in a high ranking on the candidate list, and transmits information regarding the random access code indices allocated to the M number of candidate RRHs to the UE 300 through the serving RRH 220 (S810). The UE 300 adds the random access code indices regarding the M number of RRHs in a high ranking received from the serving RRH 220 to the candidate list and manages the indices.

Meanwhile, when a failure regarding a radio link connected between the serving RRH 220 and the UE 300 occurs (S812), the serving RRH 220 transmits radio link failure occurrence information to the BBU pool 100.

Upon receiving the wireless link failure occurrence information, the BBU pool 100 transfers information regarding the random access code index allocated to the adjacent RRH_1 200 to the candidate RRH positioned in a highest ranking on the candidate list, e.g., the adjacent RRH_1 200 (S814).

The UE 300 adjusts an uplink timing using the reference time difference to d₁ stored to correspond to the adjacent RRH_1 200 positioned in the highest ranking on the candidate list (S816). Thereafter, the UE 300 generates a random access preamble using the random access code index allocated to the adjacent RRH_1 200 and subsequently transmits the random access preamble to the adjacent RRH_1 200 (S818).

When the random access preamble is detected, the adjacent RRH_1 200 transmits a detection result to the BBU pool 100. The BBU pool 100 generates a random access response on the basis of the detection result transmitted from the adjacent RRH_1 200 and subsequently transmits the random access response to the adjacent RRH_1 200. The adjacent RRH_1 200 transmits the random access response with respect to the random access preamble to the UE 300 (S820).

As the UE 300 receives the random access response, the random access procedure is completed and a radio link is established between the UE 300 and the adjacent RRH_1 200 through an RRC connection re-establishment process between the UE 300 and the adjacent RRH_1 200 (S822).

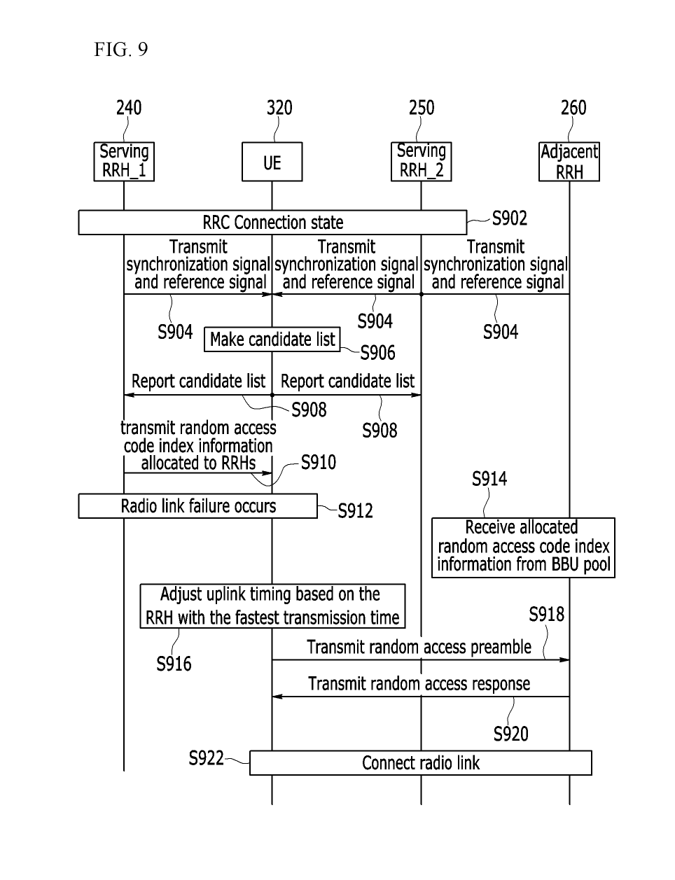

FIG. 9 is a view illustrating a procedure for handling a radio link failure according to another exemplary embodiment of the present invention. A procedure for processing a radio link failure on the basis of a communication environment illustrated in FIG. 4 will be described with reference to FIG. 9. Here, it is assumed that the serving RRH_1 240 is a main serving RRH with priority of every connection and the serving RRH_2 250 is an auxiliary serving RRH.

Referring to FIG. 9, when the UE 320 is connected to the serving to RRH_1 240 and the serving RRH_2 250 in an RRC-connected state (S902), the UE 320 receives synchronization signals and reference signals from the plurality of RRHs 240, 250, and 260 (S904).

The UE 320 performs a process of searching for and selecting a candidate RRH on the basis of the received synchronization signals and reference signals. The process (step S906 to S910) of searching for and selecting the candidate RRH and configuring and managing the candidate list are the same as the contents described above with reference to FIGS. 4 and 7. That is, when receive strength of a synchronization signal received from the adjacent RRH 260, excluding the serving RRH_1 240 and the serving RRH_2 250, continuously exceeds the preset threshold TH2 the predetermined number of times N1 and a unique identifier obtained through a reference signal received from the adjacent RRH 260 is the same the predetermined number of times N1, the UE 300 registers the adjacent RRH 260 as a candidate RRH and configures a candidate list including the candidate RRH (S906). The UE 320 periodically transmits the configured candidate list to the BBU pool 100 through the serving RRH_1 240 and the serving RRH_2 250 (S908). Upon simultaneously receiving the candidate list through the serving RRH_1 240 and the serving RRH_2 250, the BBU pool 100 allocates a random access code index for a contention-free-based random access which may be used by M number of candidate RRHs in a high ranking on the candidate list received from the serving RRH_1 240 corresponding to a main serving RRH. The BBU pool 100 transmits information regarding random access code indices allocated to the M number of candidate RRHs in a high ranking to the UE 320 through the serving to RRH_1 240 as a main serving RRH (S910). The UE 320 adds the random access code indices regarding the M number of RRHs in a high ranking received from the serving RRH_1 240 to the candidate list and manages the indices.

Meanwhile, when a failure regarding a radio link connected between the serving RRH_1 240 and the UE 320 occurs (S912), the serving RRH_1 240 transmits radio link failure occurrence information to the BBU pool 100.

Upon receiving the wireless link failure occurrence information, the BBU pool 100 transfers information regarding the random access code index allocated to the adjacent RRH 260 to the adjacent RRH 260 positioned in a highest ranking on the candidate list (S914).

The UE 320 adjusts an uplink timing regarding the adjacent RRH 260 positioned

The UE adjusts the uplink timing based on the RRH (for example, serving RRH_2 250) with the fastest transmission time using the reference time differences d₃ and d₄ stored to correspond to the serving RRH_2 250 and the adjacent RRH 260 positioned in the highest ranking on the candidate list (S916).

The UE 320 generates a random access preamble using the random access code index allocated to the adjacent RRH 260 and subsequently transmits the random access preamble to the adjacent RRH 260 (S918).

When the random access preamble is detected considering the relative reference time difference d₄ of the signal transmitted from the serving RRH_2 250, the adjacent RRH 260 transmits a detection result to the BBU pool 100. The BBU pool 100 generates a random access response on the basis of the to detection result transmitted from the adjacent RRH 260 and subsequently transmits the random access response to the adjacent RRH 260. The adjacent RRH 260 transmits the random access response to the UE 320 (S920).

As the UE 320 receives the random access response, the random access procedure is completed and a radio link is established between the UE 320, the serving RRH_2 250, and the adjacent RRH 260 through an RRC connection re-establishment process between the UE 320 and the adjacent RRH 260 (S922).

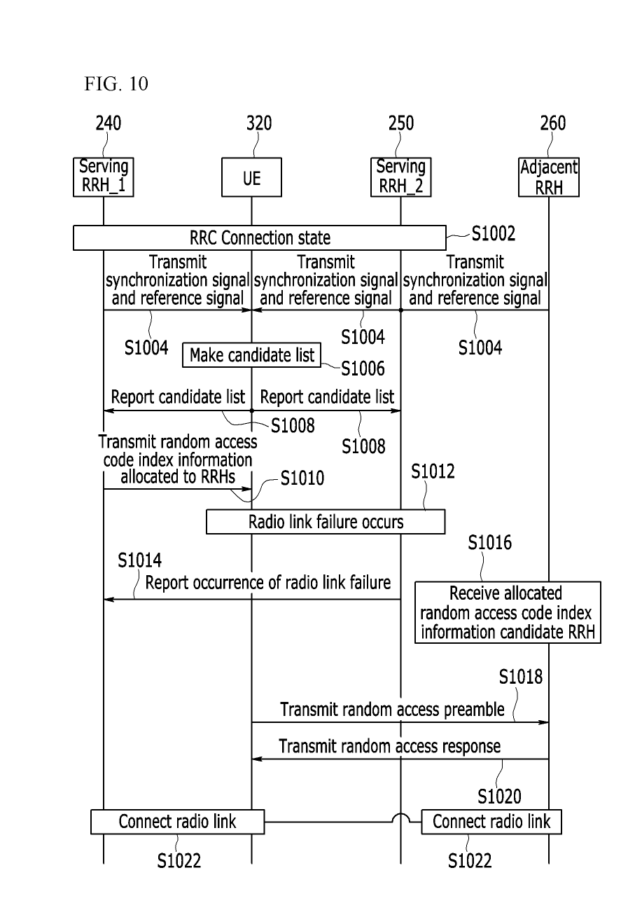

FIG. 10 is a view illustrating a procedure for handling a radio link failure according to another exemplary embodiment of the present invention. A procedure for processing a radio link failure on the basis of a communication environment illustrated in FIG. 4 will be described with reference to FIG. 10, like FIG. 9.

Referring to FIG. 10, when the UE 320 is connected to the serving RRH_1 240 and the serving RRH_2 250 in an RRC-connected state (S1002), the UE 320 receives synchronization signals and reference signals from the plurality of RRHs 240, 250, and 260 (S1004).

The UE 320 performs a process of searching for and selecting a candidate RRH on the basis of the received synchronization signals and reference signals. The process (step S1006 to S1010) of searching for and selecting the candidate RRH and configuring and managing the candidate list are the same as the process (S906 to S910) illustrated in FIG. 9, and thus, a detailed description thereof will be omitted.

Meanwhile, when a failure occurs in the radio link established between to the serving RRH_2 250 corresponding to an auxiliary serving RRH and the UE 320 (S1012), the serving RRH_2 250 transmits radio link failure occurrence information to the serving RRH_1 240 corresponding to the main serving RRH through the BBU pool 100 (S1014).

The serving RRH_1 240 transfers information regarding the random access code index allocated to the adjacent RRH 260 to the adjacent RRH 260 positioned in a highest ranking on the candidate list through the BBU pool 100 (S1016).

Since the radio link failure of the serving RRH_1 ( 240) corresponding to the main serving RRH did not occur, the UE 320 does not perform the step of adjusting the uplink timing.

The UE 320 generates a random access preamble using the random access code index allocated to the adjacent RRH 260 and subsequently transmits the random access preamble to the adjacent RRH 260 (S1018).

When the random access preamble is detected, the adjacent RRH 260 transmits a detection result to the BBU pool 100. The BBU pool 100 generates a random access response on the basis of the detection result transmitted from the adjacent RRH 260 and subsequently transmits the random access response to the adjacent RRH 260. The adjacent RRH 260 transmits the random access response to the UE 320 (S1020).

As the UE 320 receives the random access response, the random access procedure is completed and a radio link is established between the UE 320 and the adjacent RRH 260 through an RRC connection re-establishment process between the UE 320, the serving RRH_1 240 and the adjacent RRH to 260 (S1022).

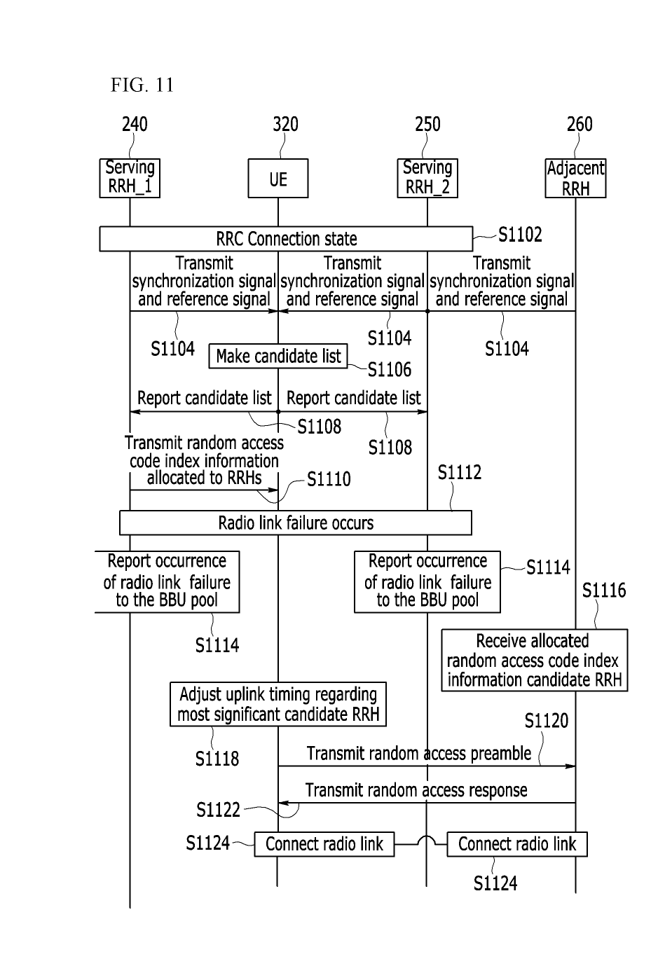

FIG. 11 is a view illustrating a procedure for handling a radio link failure according to another exemplary embodiment of the present invention. A procedure for processing a radio link failure on the basis of a communication environment illustrated in FIG. 4 will be described with reference to FIG. 11, like FIGS. 9 and 10.

Referring to FIG. 11, when the UE 320 is connected to the serving RRH_1 240 and the serving RRH_2 250 in an RRC-connected state (S1102), the UE 320 receives synchronization signals and reference signals from the plurality of RRHs 240, 250, and 260 (S1104).

The UE 320 performs a process of searching for and selecting a candidate RRH on the basis of the received synchronization signals and reference signals. The process (step S1106 to S1110) of searching for and selecting the candidate RRH and configuring and managing the candidate list are the same as the process (S906 to S910, and S1006 to S1010) illustrated in FIGS. 9 and 10, and thus, a detailed description thereof will be omitted.

Meanwhile, when failures occur at the same time in the radio link established between the serving RRH_1 240 corresponding to a main serving RRH and the UE 320 and the radio link established between the serving RRH_2 250 corresponding to an auxiliary serving RRH and the UE 320 (S1112), the serving RRH_1 240 and the serving RRH_2 250 transmit radio link failure occurrence information to the BBU pool 100, respectively (S1114).

The BBU pool 100 transfers information regarding the random access code index allocated to the adjacent RRH 260 to the adjacent RRH 260 to positioned in a highest ranking on the candidate list (S1116).

The UE 320 adjusts an uplink timing regarding the adjacent RRH 260 positioned in the highest ranking on the candidate list using the reference time difference d₄ stored to correspond to the adjacent RRH 260 positioned in the highest ranking on the candidate list (S1118).

The UE 320 generates a random access preamble using the random access code index allocated to the adjacent RRH 260 and transmits the random access preamble to the adjacent RRH 260 (S1120).

When the random access preamble is detected, the adjacent RRH 260 transmits a detection result to the BBU pool 100. The BBU pool 100 generates a random access response on the basis of the detection result transmitted from the adjacent RRH 260 and subsequently transmits the random access response to the adjacent RRH 260. The adjacent RRH 260 transmits the random access response to the UE 320 (S1122).

As the UE 320 receives the random access response, the random access procedure is completed and a radio link is established between the UE 320 and the adjacent RRH 260 through an RRC connection re-establishment process between the UE 320 and the adjacent RRH 260 (S1124).

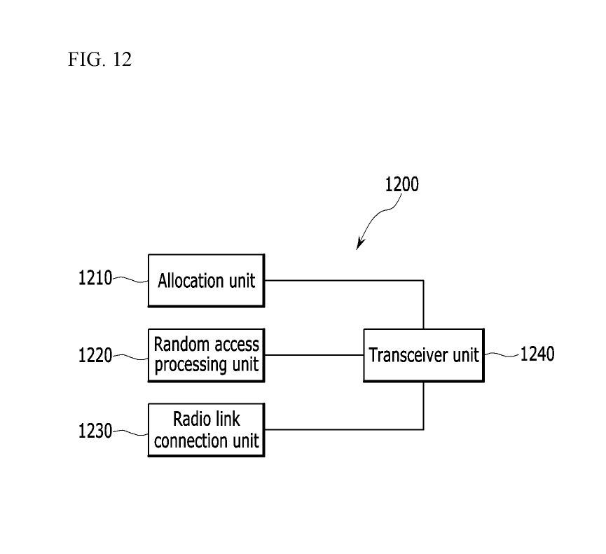

FIG. 12 is a view illustrating an apparatus for handling a radio link failure in a BS according to an exemplary embodiment of the present invention.

Referring to FIG. 12, an apparatus 1200 for handling a radio link failure includes an allocation unit 1210, a random access processing unit 1220, a radio link connection unit 1230, and a transceiver unit 1240. The allocation unit 1210, the random access processing unit 1220, the radio link connection unit to 1230, and the transceiver unit 1240 are executed according to an instruction from at least one processor to perform a corresponding function. Instructions to be performed in the processor may be stored in a memory or a storage, and the processor executes an instruction stored in the memory or the storage.

The allocation unit 1210 may be implemented in a BBU pool, and the random access processing unit 1220, the radio link connection unit 1230, and the transceiver unit 1240 may be implemented in an RRH.

The allocation unit 1210 may perform the function of the BBU pool 100 described above with reference to FIG. 6. When the allocation unit 1210 receives a candidate list regarding neighbor RRHs from a UE, the allocation unit 1210 manages the candidate list received from the UE and allocates a random access code index to at least one RRH included in the candidate list on the basis of the candidate list. The allocated random access code index is transmitted to the UE through the transceiver unit 1240.

When a failure occurs in a radio link established between a serving RRH and the UE, the random access processing unit 1220 detects a random access preamble using a random access code index allocated to an adjacent RRH positioned in a highest ranking on the candidate list and transmits a random access response with respect to the random access preamble to the UE through the transceiver unit 1240. The random access response is transmitted to the UE through the transceiver unit 1240.

When the failure occurs in the radio link established between the serving RRH and the UE, the radio link connection unit 1230 performs a process of RRC connection re-establishment between the adjacent RRH positioned in the to highest ranking on the candidate list to establish a radio link between the adjacent RRH and the UE.

The transceiver unit 1240 may include a plurality of RRHs and may be connected to the allocation unit 1210, the random access processing unit 1220, and the radio link connection unit 1230 to transmit and receive a radio signal to and from the UE.

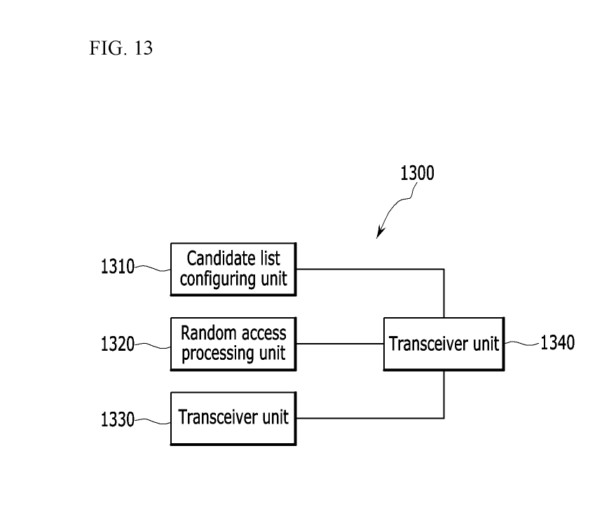

FIG. 13 is a view illustrating an apparatus for handling a radio link failure in a UE according to an exemplary embodiment of the present invention.

Referring to FIG. 13, an apparatus 1300 for handling a radio link failure includes a candidate list configuring unit 1310, a random access processing unit 1320, a radio link connection unit 1330, and a transceiver unit 1340. The candidate list configuring unit 1310, the random access processing unit 1320, and the radio link connection unit 1330 are executed according to an instruction from at least one processor to perform a corresponding function. Instructions to be performed in the processor may be stored in a memory or a storage, and the processor executes an instruction stored in the memory or the storage.

The candidate list configuring unit 1310 may perform a function of the UE 300 described above with reference to FIG. 7. The candidate list configuring unit 1310 may select a serving RRH using synchronization signals and reference signals received from a plurality of RRHs, searches for a candidate RRH, and selects the candidate RRH. When the candidate RRH is selected, a relative reference time difference of a signal received from the candidate RRH with respect to a reference time of a signal received from the serving RRH, and subsequently configures a candidate list including a unique to identifier of the candidate RRH and the calculated reference time difference.

The candidate list is transmitted to a BS through the transceiver unit 1340 and through the serving RRH. Also, when the candidate list configuring unit 1310 receives a random access code index regarding the RRH included in the candidate list through the transceiver unit 1340 from the BS, the candidate list configuring unit 1310 updates the candidate list using the received random access code index.

When a failure occurs in a wireless link established between the serving RRH and the UE, the random access processing unit 1320 performs a random access procedure with an adjacent RRH positioned in a highest ranking on the candidate list. The random access processing unit 1320 generates a random access preamble using the random access code index allocated to the adjacent RRH positioned in the highest ranking on the candidate list, and receives a random access response from the BS. The random access preamble is transmitted through the transceiver unit 1340, and the random access response is received from the BS through the transceiver unit 1340.

When a failure occurs in the radio link established between the serving RRH and the UE, the radio link connection unit 1330 performs a process of RRC connection re-establishment with the adjacent RRH positioned in the highest ranking on the candidate list to establish a radio link between the adjacent RRH and the UE.

The transceiver unit 1340 is connected to the candidate list configuring unit 1310, the random access processing unit 1320, and the radio link connection unit 1330 to transmit and receive a radio signal to and from the BS. According to an exemplary embodiment of the present invention, when a failure of a radio link established between a BS and a UE is detected due to a frequent movement of the UE which is located in a cell boundary or has high mobility, the radio link failure is rapidly handled using candidate list information regarding an adjacent RRH managed by the UE in advance, whereby a user experience data rate in consideration of enhancement of performance in a cell boundary may be maintained.

The exemplary embodiments of the present invention may not necessarily be implemented only through the foregoing devices and/or methods but may also be implemented through a program for realizing functions corresponding to the configurations of the embodiments of the present invention, a recording medium including the program, or the like. Such an implementation may be easily conducted by a person skilled in the art to which the present invention pertains from the foregoing description of embodiments.

The exemplary embodiments of the present invention have been described in detail, but the scope of the present invention is not limited thereto and various variants and modifications by a person skilled in the art using a basic concept of the present invention defined in claims also belong to the scope of the present invention.

What is claimed is:

1. A method for handling a radio link failure in a base station (BS) of a mobile communication system, the method comprising:
receiving, from a user equipment (UE), a candidate list including a candidate remote radio head (RRH) adjacent to the UE, excluding at least one serving RRH connected to the UE, among a plurality of RRHs;
allocating a random access code index to at least one candidate RRH included in the candidate list; and
transmitting, to the UE, the random access code index allocated to the at least one candidate RRH.

2. The method of claim 1, further comprising:
when a failure in a radio link established between the at least one serving RRH and the UE is detected, processing a random access between a target candidate RRH with strongest signal strength received from the UE on the candidate list and the UE; and
establishing a radio link between the target candidate RRH and the UE.

3. The method of claim 2, wherein the processing of random access includes:
receiving a random access preamble transmitted from the UE using a random access code index allocated to the target candidate RRH; and
transmitting a random response message regarding the random access preamble.

4. The method of claim 3, wherein the process of random access further includes: transmitting the random access code index allocated to the target candidate RRH to the target candidate RRH.

5. The method of claim 1, further comprising:
transmitting a synchronization signal including a physical layer cell ID and a reference signal including a unique identifier of a corresponding RRH through a plurality of RRHs, before the candidate list is received from the UE,
wherein the candidate list includes a unique identifier of the candidate RRH.

6. The method of claim 5, wherein:
the candidate list further includes a relative reference time difference of a signal received from the candidate RRH with respect to a reference signal from a reference time of a signal received from the serving RRH, and
the relative reference time difference is used as an uplink timing adjustment value for random accessing the candidate RRH.

7. The method of claim 5, wherein:
when signal strength of a synchronization signal received by the UE continuously exceeds a preset first threshold by a predetermined first number of times and a unique identifier obtained through a reference signal is the same for the first number of times, an RRH which has transmitted the corresponding synchronization signal and the reference signal is added as the candidate RRH to the candidate list, and
when signal strength of a synchronization signal received by the UE does not continuously exceed a preset second threshold by a predetermined second number of times, a candidate RRH which has transmitted the corresponding synchronization signal and the reference signal is deleted from the candidate list.

8. The method of claim 1, wherein the allocating includes:
allocating a random access code index to the candidate RRH when the candidate RRH is first reported through the candidate list; and
maintaining the random access code index allocated to the candidate RRH until the candidate RRH is deleted from the candidate list.

9. A method for handling a radio link failure in a user equipment (UE) of a mobile communication system, the method comprising:
configuring a candidate list including at least one candidate remote radio head (RRH) adjacent to the UE, excluding at least one serving RRH to which the UE is connected, among a plurality of RRHs;
receiving a random access code index of the at least one candidate RRH allocated by a base station (BS), through the serving RRH; and
adding the random access code index of the at least one candidate RRH to the candidate list.

10. The method of claim 9, further comprising:
when a failure that occurs in a radio link established between the at least one serving RRH and the UE is detected, performing random access with a target candidate RRH using a random access code index of the target candidate RRH with strongest signal strength received from the UE on the candidate list; and
connecting a radio link to the target candidate RRH.

11. The method of claim 10, wherein the configuring includes:
receiving synchronization signals including a physical layer cell ID and reference signals including a unique identifier of a corresponding RRH from the plurality of RRHs;
selecting the serving RRH and the candidate RRH from among the plurality of RRHs using the synchronizations and the reference signals; and
generating a candidate list including the candidate RRH and transmitting the generated candidate list to the BS through the serving RRH.

12. The method of claim 11, wherein the selecting includes:
selecting an RRH which has transmitted a synchronization signal with strongest signal strength among signal strengths of synchronization signals received from the plurality of RRHs, as the serving RRH; and
when signal strength of a synchronization signal among synchronization signals and reference signals received from the plurality of RRHs continuously exceeds a preset first threshold by a predetermined number of times and a unique identifier transmitted through a received reference signal is the same for the first number of times, selecting an RRH which has transmitted the corresponding synchronization signal and the reference signal as the candidate RRH.

13. The method of claim 11, further comprising:
the selecting further includes: when signal strength of a synchronization signal of the candidate RRH does not continuously exceed a preset second threshold by a predetermined second number of times, deleting the corresponding candidate RRH from the candidate list.

14. The method of claim 11, wherein the transmitting includes:
calculating a relative reference time difference of a synchronization signal received from the candidate RRH with respect to a reference time of a synchronization signal received from the at least one serving RRH; and
generating a candidate list including a unique identifier of the candidate RRH obtained through the reference signal received from the candidate RRH and the relative reference time difference of the candidate RRH.

15. The method of claim 14, wherein the performing of random access includes: adjusting an uplink timing based on a RRH with the fastest transmission time using relative reference time differences calculated with respect to the serving RRH and the target candidate RRH.

16. An apparatus for handling a radio link failure in a user equipment (UE) of a mobile communication system, the apparatus comprising:
a candidate list configuring unit selecting a candidate remote radio head (RRH) adjacent to the UE, excluding a serving RRH to which the UE is connected, among a plurality of RRHs connected to a single baseband unit (BBU) pool, configuring a candidate list including the candidate RRH, adding a random access code index allocated to the candidate RRH to the candidate list, and managing the candidate list;
a random access processing unit performing random access with a target adjacent RRH using a random access code index allocated to the target adjacent RRH with strongest signal strength received from the UE, on the candidate list, when a failure occurs in a radio link established between the serving RRH and the UE;
a radio link connection unit connecting the target candidate RRH and a radio link, when the random access is completed.

17. The apparatus of claim 16, further comprising a transceiver unit receiving synchronization signals each including a physical layer cell ID and reference signals including a unique identifier of a corresponding RRH from the plurality of RRHs,
wherein the candidate list configuring unit selects an RRH which has transmitted a synchronization signal with strongest signal strength among signal strengths of synchronization signals received from the plurality of RRHs, as the serving RRH, and when a signal strength of a received synchronization signal continuously exceeds a preset first threshold by a predetermined first number of times and a unique identifier transmitted through the received reference signal is the same for the first number of times, the candidate list configuring unit selects an RRH which has transmitted the corresponding synchronization signal and the reference signal, as the candidate RRH.

18. The apparatus of claim 16, wherein the radio link connection unit performs a radio resource control (RRC) connection re-establishment procedure to connect the target candidate RRH and a radio link.

19. The apparatus of claim 17, wherein:
the candidate list configuring unit calculates a relative reference time difference of a synchronization signal received from the candidate RRC with respect to a reference signal of a synchronization signal received from the serving RRH, and
the candidate list includes a unique identifier of the candidate RRH obtained through a reference signal received from the candidate RRH and a relative reference time difference of the candidate RRH.

20. The apparatus of claim 19, wherein the random access processing unit adjusts an uplink timing based on a RRH with the fastest transmission time using the relative reference time differences calculated with respect to the serving RRH and the target candidate RRH.
